(19) United States
(12) Patent Application Publication
(10) Pub. No.: US 2010/0089924 A1
(43) Pub. Date: Apr. 15, 2010

(54) METAL CONTAINERS

(75) Inventors: Mark Jeremy Rowland, Oxfordshire (GB); Matthieu Jacques Dupuis, Paris (FR)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Crown Packaging Technology, Inc., Alsip, IL (US)

(21) Appl. No.: 12/529,444

(22) PCT Filed: Feb. 22, 2008
(86) PCT No.: PCT/EP08/52207

§ 371 Date: Sep. 1, 2009

(30) Foreign Application Priority Data
Mar. 2, 2007 (GB) 0704054.6

(51) Int. Cl. B65D 17/50; B05D 7/22; B21D 51/40; B21D 51/46

(52) U.S. Cl. 220/270; 413/8; 413/18; 220/260

(57) ABSTRACT

A metal container or component part of a metal container (e.g. a can end or sidewall of a can body) has an aperture defined by a cut edge about the periphery of the aperture, with a cover element sealed to the outward-facing surface of the can end so as to extend over and cover the aperture. A film of lacquer is directly applied (without the presence of an intermediate primer layer) to the inward-facing of the container/component part so as to coat the entirety of the cut edge and all or part of the inward-facing surfaces of both the can end and that part of the cover element located radially inward of the cut edge, thereby inhibiting corrosion of the cut edge. The invention is particularly suitable for can ends. The invention also relates to a method of making a can end to the invention.

### CROSS-REFERENCE TO RELATED APPLICATIONS

This application is the National Stage of International Application No. PCT/EP2008/052207, filed Feb. 22, 2008, which claims the benefit of GB Application No. 0704054.6, filed Mar. 2, 2007, the disclosures of which are incorporated herein by reference in their entirety.

### Technical Field

The present invention relates to a metal container or a component part of a metal container (e.g. can end or sidewall of a can body), the container or component part containing an aperture with a cut edge, adapted to be closed by a separate cover element. The container or component part is adapted to inhibit corrosion to the cut edge.

Without limiting the generality of the present invention, the component part may, for example, be a can end for a container and/or may be a sidewall of a container. Further, the aperture may be for the dispensing of a product from the container and/or may be a venting or vacuum release feature.

### BACKGROUND ART

In the field of metal packaging, metal can ends with dispensing apertures closed by plugs, peelable membranes or other forms of cover element are known. The outward-facing surface of the can end is provided with a coating of heat sealable material—either local to the aperture or covering the entire outward-facing surface of the can end. The coating of heat sealable material enables the use of heat to bond a cover element (for example, a peelable membrane) to the can end to cover the dispensing aperture and thereby provide a hermetic seal.

The aperture is formed by cutting out a section from the metal can end. However, in so forming the aperture, a cut edge of bare metal is formed around the periphery of the aperture. The bare metal of the cut-edge is therefore vulnerable to corrosion. Such corrosion is particularly undesirable in the packaging of foodstuffs because it can cause contamination of the foodstuff. The risk of corrosion is particularly prevalent for liquid foodstuffs or foodstuffs having a high moisture content.

A complex and expensive solution to the above problems is found in U.S. Pat. No. 4,461,605 (SWISS ALUMINIUM LTD) Jul. 24, 1984, which discloses a can end with an aperture defining an exposed cut edge of bare metal about the periphery of the aperture. U.S. Pat. No. 4,461,605 uses multiple manufacturing operations to provide the protection to the exposed cut edge of metal. In a first step, an “adhesive primer” is applied to the region of the can end about the cut edge. The primer is then dried in a separate operation. Once the primer has been dried, a “plastisol layer” is then applied over the primer. Finally, a heat treatment process is used to “gel” the plastisol layer. The requirement for so many varied manufacturing operations increases the complexity in manufacture, as well as the cost of manufacture. Further, plastisols generally contain PVC. Manufacture of PVC can release toxic effluents during its manufacture, such as dioxin. Further, disposal by incineration can generate hydrogen chloride. Consequently, the use of plastisols has disadvantages for health & safety and environmental reasons.

An alternative and even more complex solution is described in U.S. Pat. No. 3,355,059 (A. E. BALOCCA ET AL) Nov. 28, 1967. This shows a can end with an aperture, having a cover panel which includes two aluminium foil patches bonded over the aperture to adhere on opposing sides of the can end. The patch on the underside of the can end is planar (i.e. flat) and is the thinner of the two patches. However, the patch on the upper side of the can end is embossed into the aperture and bonded to the lower patch by a complex three-layered structure of heat sealable adhesive sandwiched between two polymer layers of synthetic resin. In use, a consumer would pull on the upper patch to remove the cover panel from the can end. The adhesive ensures that the two aluminium patches remain adhered to each other during removal of the cover panel. However, the peeling force applied by the consumer has to be large enough not only to break the bond between the upper patch and the can end, but also the bond between the lower patch and the can end. This construction is also very complex—requiring two separate patches of aluminium foil (or similar metal) bonded to both the upper and lower faces of the can end via a multi-layered structure of adhesive and polymer layers. Additionally, embossing the upper patch into the aperture can leave voids between the cut edge and the upper patch (as best shown in FIGS. 1 & 2 of U.S. Pat. No. 3,355,059), with the consequent risk of oxidation of the exposed metal of the cut edge.

A further alternative solution to the problems outlined in paragraph 4 is disclosed in EP 0059635 B (TOYO SEIKAN KAISHA LIMITED) Jun. 5, 1985. EP 0059635 B discloses a can end having a dispensing aperture cut out of the can end, leaving a cut edge of bare metal about the periphery of the aperture. Two separate layers of thermoplastic resin are heat sealed to the outward and inward-facing surfaces respectively of the can end around the periphery of the aperture and are formed into a grommet/sleeve which extends about and coats the bare metal of the cut edge. The grommet/sleeve construction thereby inhibits corrosion of the cut edge. A cover element is then bonded directly onto that portion of the grommet/sleeve that is provided on the outward-facing surface of the can end. However, although EP 0059635 B is directed at the same problem as the present invention, it requires accurate placement of the separate layers of thermoplastic resin that form the grommet/sleeve in order to ensure that the cut edge is adequately coated and protected, thereby increasing the costs and complexity of the manufacturing process of the can end. Further, by bonding the cover element directly to that part of the grommet/sleeve provided on the outward-facing surface of the can end, the cover element stands proud of the can end. As a consequence, the edge of the cover element is vulnerable to being caught on foreign objects (e.g. other containers) and thereby damaged.

In a final alternative, U.S. Pat. No. 3,339,788 A (NATIONAL CAN CORPORATION) Sep. 5, 1967 discloses a can end having a dispensing aperture with a cover element attached to cover and seal the aperture. As above, the dispensing aperture is cut out of the can end, leaving a cut edge of bare metal about the periphery of the dispensing aperture. U.S. Pat. No. 3,339,788 A further discloses the use of an adhesive covering tape on the inward-facing surface of the can end which adheres to both the inward-facing surface of the can end local to the aperture and the cover element itself, with the object of preventing the product inside a can incorporating the can end from coming into contact with the bare metal of the cut edge. However, as can be seen in FIGS. 3 and 4 of U.S. Pat. No. 3,339,788 A, the adhesive covering tape does not come into direct contact with the cut edge, thereby leaving a void/air gap between the covering tape and the cut edge. The presence of this void/air gap results in the risk of corrosion on the bare metal of the cut edge if there is any moisture present within the void/air gap. Generally, self-adhesive covering tapes are not suitable for use in retort processing, with the environmental conditions of retort processing (i.e. temperatures in excess of 100° C. and high humidity) causing the adhesive of the covering tape to become detached from the can end.

Consequently, there is a need for a container or component part of a metal container having an aperture and including an improved, simplified means of inhibiting corrosion to the bare metal of the cut edge of the aperture.

### DISCLOSURE OF INVENTION

Accordingly, there is provided a metal container or a metal component part of a container, the container/component part comprising an aperture, a cut edge defining the periphery of the aperture;
a cover element bonded to the outward-facing surface of the container/component part to extend over and seal the aperture;
a protective lacquer film applied to coat the entirety of the cut edge and all or part of the inward facing surfaces of both the container/component part and that part of the cover element which lies radially inward of the cut edge, thereby inhibiting corrosion of the cut edge;
characterised in that the film is adapted to be directly applied to the surface of the exposed metal of the cut edge and the inward facing surfaces of the container/component part and cover element without an intermediate primer layer to provide an interior exposed surface of the container/component part, and on removal of the cover element the lacquer film tears about the periphery of the aperture to form a first lacquer film portion remaining attached to the container/component part and a second lacquer film portion remaining attached to the detached cover element.

The aperture may be an aperture used for dispensing a product, such as milk or other liquids. Alternatively, the aperture may be a venting aperture designed to ensure the easy pouring of liquid through an adjacent dispensing aperture. Alternatively, the aperture might be a vacuum release feature to enable the easy opening of containers whose contents are packed under vacuum conditions. The aperture may be formed in a metal can end which is attached to a container body. Alternatively, the aperture may be formed in the sidewall of a container body itself.

The component part may be a can end or a sidewall of a can body. Typically, the container/component part would be formed from a sheet material comprising a metal substrate with a relatively thin protective coating on either or both of its outward and inward-facing surfaces suitable for inhibiting corrosion of the metal substrate. However, if the container/component part is formed from “tinplate” (i.e. steel plate coated with a thin layer of tin), the layer of tin may itself act to protect the steel from corrosion, dependent on the aggressiveness of the product within the container. The metal substrate of the container/component part may be any metal, with steel, tinplate or aluminium being found particularly suitable.

When it is desired to bond the cover element onto the container/component part by heat sealing, heat sealable coatings may be provided on the corresponding mating surfaces of the cover element and the container/component part. The heat sealable material may be located local to the aperture or may cover the entirety of the outward-facing surface of the container/component part. Known heat seal coatings may be used for the heat sealable material, with polypropylene typically being a suitable constituent material.

Depending on the particular metal used to form the container/component part, a protective coating may also be needed on the inward-facing surface of the container/component part to inhibit corrosion of the metal substrate. Known epoxy coatings would be suitable for this use and are often used as coatings in the manufacture of metal cans from sheet metal. Epoxy coatings are preferred when heat sealing the cover element to the outward-facing surface of the container/component part because the epoxy coating is able to resist the heat imparted by the heat seal tooling, thereby minimising the risk of the inward facing surface of the container/component part becoming bonded to the tooling itself.

As specified in claim 1, the cover element must “extend over” the aperture. In other words, the cover element is not embossed within the aperture. It is preferable for the cover element to be a peelable membrane. In this case, the cover element is generally of a laminate construction, comprising a single foil metal core for strength, with a layer of heat sealable material on its inward-facing surface to enable the cover element to be heat sealed to the container/component part. Typically, the heat sealable material contains one or more thermoplastic polymers, such as polypropylene. However, the cover element may be bonded to the can end by other known means, such as the use of adhesive. Optionally, the outward-facing surface of the cover element is coated with a layer of polyethylene terephthalate (PET) or similar material to protect the metal core and/or to allow overprinting with text/graphics. The cover element conveniently includes a pull tab to assist in its removal from the container/component part.

Direct application of the protective lacquer film to the cut edge without the onerous requirement for an intermediate primer greatly simplifies the manufacturing process compared to that of U.S. Pat. No. 4,461,605. The protective lacquer film is preferably epoxy-based. It has been found particularly beneficial for the lacquer film to include a dispersion of a thermoplastic polymer. Advantageously, the thermoplastic dispersion contains polypropylene and/or a modified polypropylene. The “modified” polypropylene conveniently takes the form of polypropylene grafted with maleic anhydride. This polypropylene/“modified” polypropylene is then dispersed within an epoxy-phenolic base to provide the lacquer. Lacquers including the above dispersion have the advantage that they can cure at relatively low temperatures (i.e. ˜150° C.) relative to conventional purely epoxy-based lacquers without the polypropylene dispersion (curing temperatures normally around ˜190° C.). Tests performed using conventional epoxy lacquer to provide the protective lacquer film without the dispersion of polypropylene/modified polypropylene, resulted in poor adhesion with heat sealable coatings provided on the underside of the cover element. This poor adhesion occurred even when pre-treating the cover element's heat sealable coating using corona or flame treatments to improve adhesion. The effect of poor adhesion was that on peeling to remove the cover element, the film of epoxy lacquer remained in place over the aperture, thereby obstructing the aperture. The lacquers of the present invention including the previously described dispersion of polypropylene or modified polypropylene overcome these difficulties.

It has been found that lacquer films having the above dispersion are good at bonding to other thermoplastic polymers (e.g. heat seal coatings), epoxy-based coatings and/or bare metal without the need for any intermediate layer (such as the intermediate primer required by U.S. Pat. No. 4,461,605). The lacquer film can be applied directly to the bare metal of the cut edge without the additional manufacturing steps of i) primer application and ii) drying of the primer. Put simply, the manufacturing operations required to provide cut edge protection against corrosion are both simpler and cheaper than those of U.S. Pat. No. 4,461,605.

Lacquers with this dispersion are also particularly good at bonding with coatings comprising polypropylene as a significant constituent element; for example, heat seal coatings. This is a significant advantage of the present invention because heat seal coatings often include polypropylene and are generally difficult for other materials to bond to. As detailed above, it was found in tests that the lacquer film remained bonded to a polypropylene-based heat sealable layer provided on the underside of the cover element during removal of the cover element. Consequently, the lacquer film composition overcame the problem of the lacquer film separating from the cover element and obstructing the aperture. The lacquer film composition has also been found to assist in the lacquer film tearing “cleanly” about the aperture periphery on removal of the cover element and thereby reduces the risk of dispensing of the container's contents being impeded. Also, such a lacquer composition has been found to remain adhered to the inward-facing surface of the container/component part and cover element of the present invention even when subject to the temperatures (in excess of 100° C.) and humidity found within a retort.

A lacquer film including such a dispersion of polypropylene or modified polypropylene is also thought to have the following advantages: when wet (before curing of the lacquer), surface energy effects cause the lacquer film to reticulate on the surface of the cover element. This causes the film thickness at the bare metal of the cut edge to increase, thereby providing a thicker barrier to inhibit corrosion.

When applied to a can end for a container, having the lacquer film only applied to the inward-facing surface of the can end and cover element results in a simpler construction relative to the grommet/sleeve construction of EP 0059635 B and minimises the distance by which the cover element is offset from above the outward-facing surface of the can end. This reduced offset assists in reducing the risk of damage to the cover element from snagging with foreign objects (e.g. other containers) because the cover element is less exposed. Where the cover element is made of material thinner than that of the can end—which will generally be the case when using a cover element with a foil laminate construction—such protection is particularly beneficial.

Preferably, the protective lacquer film is applied by spraying onto the inward-facing surface of the container/component part after the cover element has been sealed onto the container/component part. Spray-application of the lacquer provides the benefits of ensuring complete coverage of lacquer film about the cut edge at minimal cost. Spray application has been found to reduce the risk of voids/air gaps forming between the lacquer film and the cut edge, as occurs with U.S. Pat. No. 3,339,788 A. Avoiding such voids/air gaps and ensuring direct contact between the lacquer film and the cut edge reduces the risk of corrosion to the bare metal of the cut edge prior to removal of the cover element. Further, by maximising the area of lacquer film in contact with the cover element, on removal of the cover element there is a reduced risk of the lacquer film completely detaching from the cover element, rather than tearing cleanly around the cut edge of the aperture.

According to a second aspect of the present invention, there is provided a method of manufacturing a component part of a metal container as claimed in any one of claims 1 to 9, the component part being a can end and the method having the following successive steps:
i. cutting and shaping a sheet of metal to form the can end;
ii. cutting an aperture in the can end to thereby leave a cut edge of bare metal defining the periphery of the aperture;
iii. bonding a cover element to the outward-facing surface of the can end to cover the aperture;
iv. using a spray means to apply a film of lacquer to the can end to thereby directly coat the entirety of the cut edge and all or part of the inward-facing surfaces of both the can end and that part of the cover element which lies radially inward of the cut edge, without the use of an intermediate primer layer; and
v. curing the lacquer.

The spray means may include any conventional means such as a nozzle arrangement. The sheet of metal may comprise a protective coating on either or both of its outward and inward-facing surfaces—as described above. The cover element and lacquer film are also as described above.

The spray means and can end may be stationary relative to each other during spraying. Alternatively, the spray means and the can end may be rotated relative to each other during the spraying process to ensure that the cut edge of bare metal is thoroughly coated with a film of lacquer.

### BRIEF DESCRIPTION OF FIGURES IN THE DRAWINGS

An embodiment of the present invention is described below and is shown in the accompanying figures:

FIG. 1 shows a perspective view from above of a can incorporating a can end of the present invention (shown with a cover element attached).

FIG. 2 corresponds to FIG. 1, but with the cover element removed.

FIG. 3 shows a detail plan view of the dispensing aperture of the can end of FIG. 2 when viewed from above.

FIG. 4 shows a view through section A-A of the can end of FIG. 3 before application of the protective lacquer film (with cover element attached).

FIG. 5 shows a view through section A-A of the can end of FIG. 3 after application of the protective lacquer film (with cover element attached).

FIG. 6 corresponds to FIG. 5, but following removal of the cover element from the can end.

FIG. 7 shows spray application of the protective lacquer film to the inward-facing surface of the can end of the present invention.

### MODE(S) FOR CARRYING OUT THE INVENTION

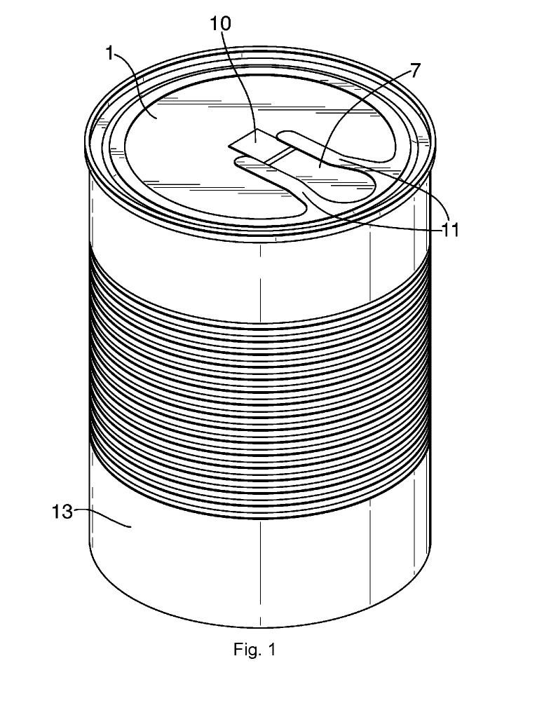

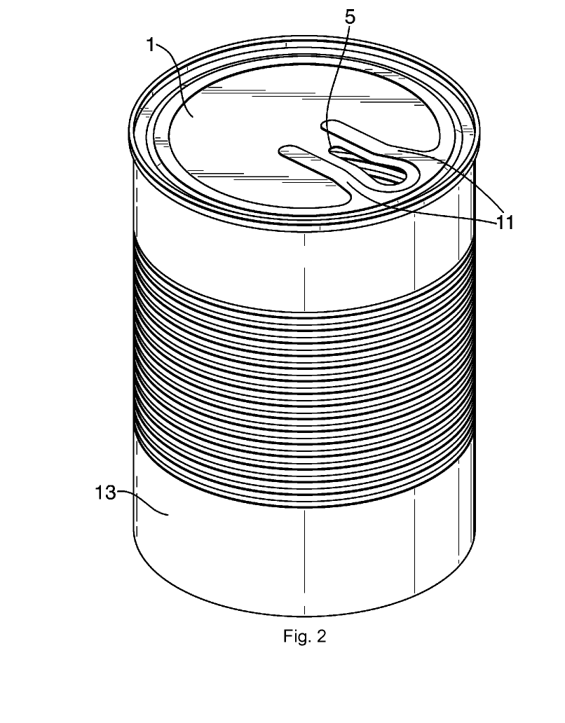

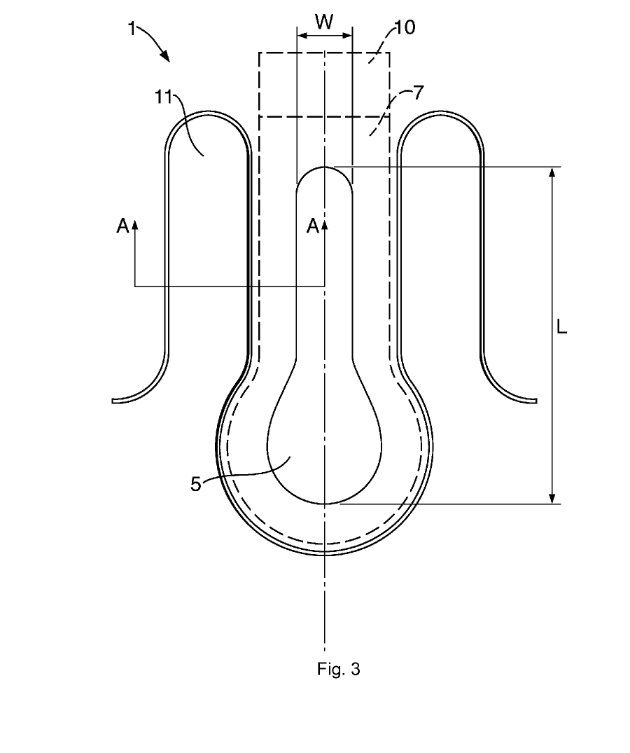

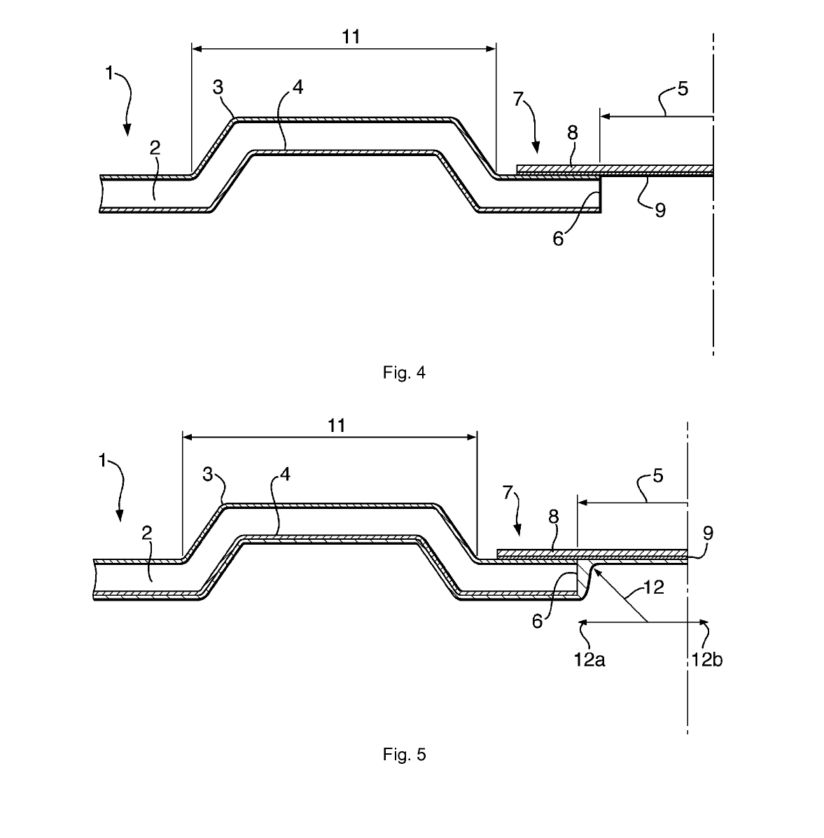

As illustrated in FIGS. 4, 5 and 6, a can end 1 is formed from a sheet of metal comprising a metal substrate 2 pre-coated with a heat sealable coating 3 containing polypropylene on the outward-facing surface of the metal substrate. An epoxy-based protective coating 4 is provided on the inward-facing surface of the metal substrate 2, the epoxy being a good inhibitor of corrosion. In the embodiment described, the metal substrate 2 is steel plate of 0.17 mm gauge. A dispensing aperture 5 is cut into the can end 1, thereby leaving the periphery of the aperture with a cut edge 6 of exposed bare metal (see FIG. 4). In the embodiment shown in the drawings, a cover element 7 is heat sealed to the outward-facing surface of the can end 1 to form a hermetic seal over the aperture 5. The cover element 7 has a foil metal substrate 8 of aluminium, the inward-facing surface of which includes a heat sealable coating 9 containing polypropylene. The cover element 7 also includes a tab portion 10 (see FIG. 1). The aperture 5 is elongated in profile, with a length L of 20 mm and a minimum width W of 3 mm as shown in FIG. 3. In the present embodiment, the cover element 7 is sealed onto the can end 1 to a width of ˜3 mm outward of the cut edge 6. The can end 1 includes a raised portion 11 which extends about three sides of the aperture 5 (see FIG. 3) and the remainder of the circumference of the can end. The raised portion 11 is formed so that it is higher than the cover element 7, thereby partially shielding/protecting the cover element as well as increasing the rigidity of the can end 1.

A film of lacquer 12 is applied by spraying to directly cover and coat:
i. the entirety of the cut edge 6; and
ii. all or part of the inward-facing surface of the cover element 7 located radially inward of the cut edge.

The film of lacquer 12 also extends radially outward of the cut edge 6 to cover all or part of the inward-facing surface of the can end 1.

In the embodiment described above, the lacquer film 12 comprises a dispersion of polypropylene grafted with maleic anhydride, provided within an epoxy-phenolic base. A consequence of the lacquer film's composition is that no intermediary layer is required between:
i. the lacquer film 12; and
ii. the cut edge 6,/the epoxy coating 4 and heat sealable coating 9 provided on the inward facing surfaces of the can end 1 and cover element 7 respectively.

Further, there is no requirement for corona or flame pre-treatment of the heat sealable coating 9 on the cover element to improve adhesion with the lacquer film 12.

Note that where the can end 1 is to be seamed onto a container body, it is preferred if the lacquer film 12 does not extend to cover all of the inward-facing surface of the can end 1 because it can interfere with the seaming compound that is used during seaming. No lacquer extends onto the outward-facing surface of the can end 1.

Note that for the purpose of illustrating the present invention, the thickness of the coatings 3, 4, 9 and lacquer film 12 shown in FIGS. 4 to 6 is deliberately exaggerated relative to the thickness of the metal substrate 2 of the can end 1.

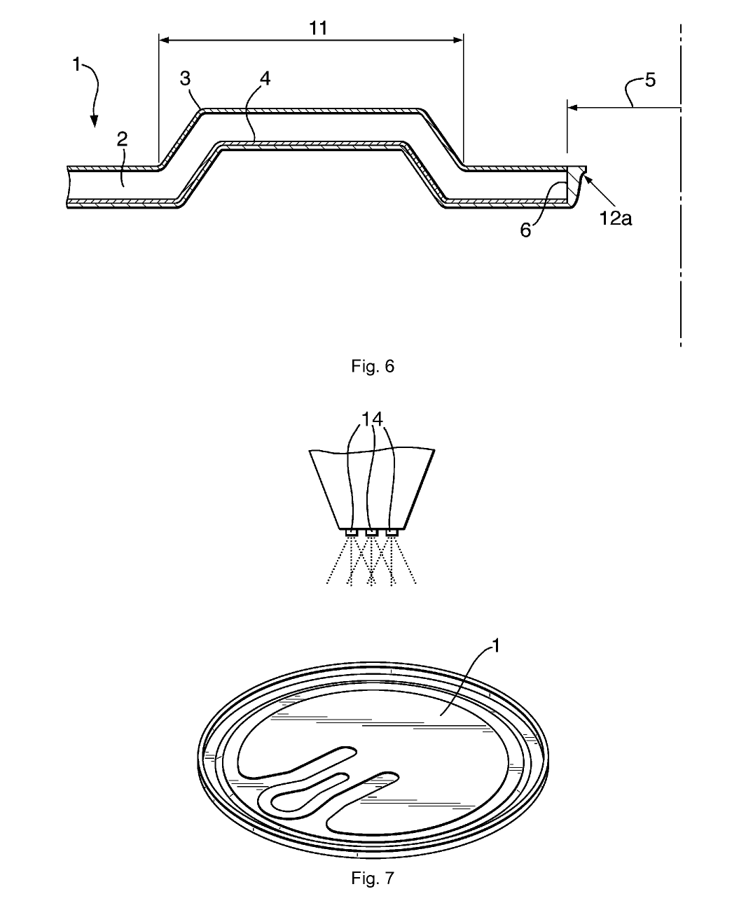

In the present embodiment, the can end 1 is attached to a can body 13 by seaming. The cover element 7 is removed from the can end 1 by a consumer pulling the tab portion 10 and peeling the cover element 7 from the can end 1. As shown in FIG. 6, on removal of the cover element 7, the lacquer film 12 forms a clean tear about the periphery of the aperture 5, separating into a first lacquer film portion 12a remaining adhered to the inward-facing surface of the can end 1 and a second lacquer film portion 12b remaining bonded to the inward-facing surface of the cover element 7. The clean tear of the lacquer film 12 about the periphery of the aperture 5 also reduces any risk of dispensing of the contents (not shown) of the can body 13 being impeded.

As shown in FIG. 7, the film of lacquer 12 is applied by spraying onto the inward-facing surface of the can end 1 after the cover element 7 has been sealed in place. In the embodiment shown, the can end 1 and spray nozzle(s) 14 are stationary relative to each other. In an alternative embodiment, the spray nozzle(s) 14 and can end 1 rotate relative to each other.

The embodiment described above and shown in the figures is merely one of many alternative suitable embodiments of the present invention and is not to be understood to restrict the scope of the present invention.

1. A metal container or a metal component part of a container, the container/component part comprising:
an aperture, a cut edge defining the periphery of the aperture;
a cover element bonded to an outward-facing surface of the container/component part that extends over and seals the aperture;
a protective lacquer film applied to coat the entirety of the cut edge and at least part of the inward facing surfaces of both the container/component part and that part of the cover element which lies radially inward of the cut edge, thereby inhibiting corrosion of the cut edge;
the film is directly applied to the exposed metal surface of the cut edge and the inward facing surfaces of the container/component part and cover element without an intermediate primer layer such that on removal of the cover element the lacquer film is configured to tear about the periphery of the aperture to form a first lacquer film portion remaining attached to the container/component part and a second lacquer film portion remaining attached to the detached cover element.

2. A container/component part as claimed in claim 1, wherein the directly applied lacquer film is adapted to remain bonded to the container/component part and cover element at temperatures up to 135° C.

3. A container/component part as claimed in claim 1, wherein the directly applied lacquer film is adapted to directly bond with coatings containing one or more thermoplastic polymers.

4. A container/component part as claimed in claim 1, wherein the directly applied lacquer film comprises a dispersion of polypropylene grafted with maleic anhydride, provided within an epoxy-phenolic base.

5. A container/component part as claimed in claim 1, wherein the directly applied lacquer film comprises a dispersion of polypropylene provided within an epoxy-phenolic base.

6. A container/component part as claimed in claim 1, wherein:
the cover element comprises a single layer of metal foil provided with a heat sealable coating;
the container/component part comprising a metal sheet provided with an epoxy coating;
the directly applied lacquer film adhering directly to the coatings of the cover element and the container/component part to provide an interior exposed surface of the container/component part.

7. A container/component part as claimed in claim 1, wherein the lacquer film is applied by spraying onto the inward-facing surfaces of the container/component part and cover element after the cover element has been sealed onto the container/component part.

8. A container/component part as claimed in claim 1, wherein the aperture has a mean width less of than 4 millimetres.

9. A component part as claimed in claim 1, wherein the component part is a can end and the outward-facing surface of the can end comprises a raised portion which extends about a majority of the periphery of the cover element, such that the cover element is flush with or beneath the level of the raised portion.

10. A method of manufacturing a component part of a metal container, the component part being a can end and the method having the following successive steps:
i. cutting and shaping a sheet of metal to form the can end;
ii. cutting an aperture in the can end to thereby leave a cut edge of bare metal defining the periphery of the aperture;
iii. bonding a cover element to the outward-facing surface of the can end to cover the aperture;
iv. spraying a film of lacquer to the can end to thereby directly coat the entirety of the cut edge and at least part of the inward-facing surfaces of both the can end and that part of the cover element which lies radially inward of the cut edge, without the use of an intermediate primer layer; and
v. curing the lacquer.
